(19) United States
(12) Patent Application Publication
(10) Pub. No.: US 2009/0074492 A1
(43) Pub. Date: Mar. 19, 2009

(54) Belt Rotating Device and Image Forming Apparatus

(75) Inventor: Michiaki ITO, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/212,766

(22) Filed: Sep. 18, 2008

(30) Foreign Application Priority Data
Sep. 18, 2007 (JP) 2007-240708

(51) Int. Cl. G03G 15/00

(52) U.S. Cl. 399/388

(57) ABSTRACT

A belt rotating apparatus capable of improving a durability with respect to flexion fatigue of a belt and capable of reducing the occurrence of the breakage of the belt; and an image forming apparatus having the belt rotating device are supplied. The belt rotating device includes a belt that is wound on a roller driven by a predetermined driving means; and a meander prevention member that is slidably contacted with an end surface of the belt for preventing a meander of the belt. In the belt rotating device, a friction reduction agent for reducing slide friction with respect to the meander prevention member is used to coat at least an end surface of the belt.

### FIELD OF THE INVENTION

1. Field of the Invention

The invention relates to a belt rotating device to rotate a belt and an image forming apparatus having the belt rotating device.

### BACKGROUND OF THE INVENTION

Conventionally, a kind of the image forming apparatus is proposed, for example, as disclosed in a patent document 1 mentioned below, which has a belt rotating device that is wound on a driving roller and a rotation supporting member to rotate a conveyance belt conveying a print medium. The image forming apparatus forms toner images of respective colors of yellow, magenta, cyan and black on respective image carrying bodies, and transfers these toner images one by one on the print medium by the movement of the conveyance belt.

Then, in the image forming apparatus, in order to prevent color deviation of the toner images that were transferred on the print medium, that is caused by the meander of the conveyance belt, a regulation board is furnished on one end surface of the driving roller, when the conveyance belt is moving, the one end surface of the conveyance belt is slidably contacted to the regulation board, the meander of the conveyance belt is regulated.

Patent document 1: Japan patent publication 11-202591.

However, in the image forming apparatus, when an approaching force caused by that the conveyance belt approaches the regulation board and slides on the regulation board acts greatly, because the frictional force between the contact surfaces of the regulation board and the conveyance belt becomes great, a flexion fatigue occurs on the end surface of the conveyance belt and the conveyance belt is damaged.

### SUMMARY OF THE INVENTION

It is, therefore, an object of the invention to provide a belt rotating device and an image forming apparatus having the belt rotating device capable of solving the above problem.

An aspect of the invention is to provide a belt rotating device. The belt rotating device comprises a belt that is wound on a roller driven by a predetermined driving means; and a meander prevention member that is slidably contacted with an end surface of the belt for preventing a meander of the belt, wherein a friction reduction agent for reducing slide friction with respect to the meander prevention member is formed to coat at least the end surface of the belt.

Another aspect of the invention is to provide an image forming apparatus. The image forming apparatus comprises a belt rotating device for rotating a belt, wherein the belt rotating device, includes: a belt that is wound on a roller driven by a predetermined driving means; and a meander prevention member that is slidably contacted with an end surface of the belt for preventing a meander of the belt; wherein a friction reduction agent for reducing slide friction with respect to the meander prevention member is formed to coat at least the end surface of the belt.

### EFFECT OF THE PRESENT INVENTION

According to the present invention, it is possible to improve the durability with respect to the flexion fatigue of the belt and to reduce the occurrence of the breakage of the belt.

The above and other objects and features of the present invention will become apparent from the following detailed description and the appended claims with reference to the accompanying drawings.

### BRIEF DESCRIPTION OF THE DRAWINGS

FIG. 1 is a cubic diagram for showing a structure of a belt rotating device;

FIG. 2 is a structure diagram of an image forming apparatus when it is a printer in embodiment 1;

FIG. 3 is a front diagram for showing a structure of a belt rotating device;

FIG. 4 is a side diagram for showing a structure of a belt rotating device;

FIG. 5 is a diagram for showing an endless belt that is coated with friction reduction agent;

FIG. 6 is an explanatory diagram concerning a generation of an endless belt;

FIG. 7 is an explanatory diagram concerning a coating of friction reduction agent to an endless belt;

FIG. 8 is a diagram for showing an endless belt that is stuck reinforcement tape;

FIG. 9 is a diagram for showing a result of a durability evaluation with respect to an image forming apparatus of embodiment 1;

FIG. 10 is a diagram for showing a result of a durability evaluation with respect to an image forming apparatus of embodiment 2;

FIG. 11 is a front diagram for showing a structure of a belt rotating device;

FIG. 12 is a structure diagram of an image forming apparatus when it is a printer in embodiment 2;

FIG. 13 is an explanatory diagram for explaining a calculation a friction coefficient; and

FIG. 14 is an explanatory diagram for showing a main part of a belt rotating device in embodiment 2.

### DETAILED DESCRIPTION OF THE PREFERRED EMBODIMENTS

Embodiments of the invention will be described in detail hereinbelow with reference to the drawings.

### Embodiment 1

### Structure of Embodiment 1

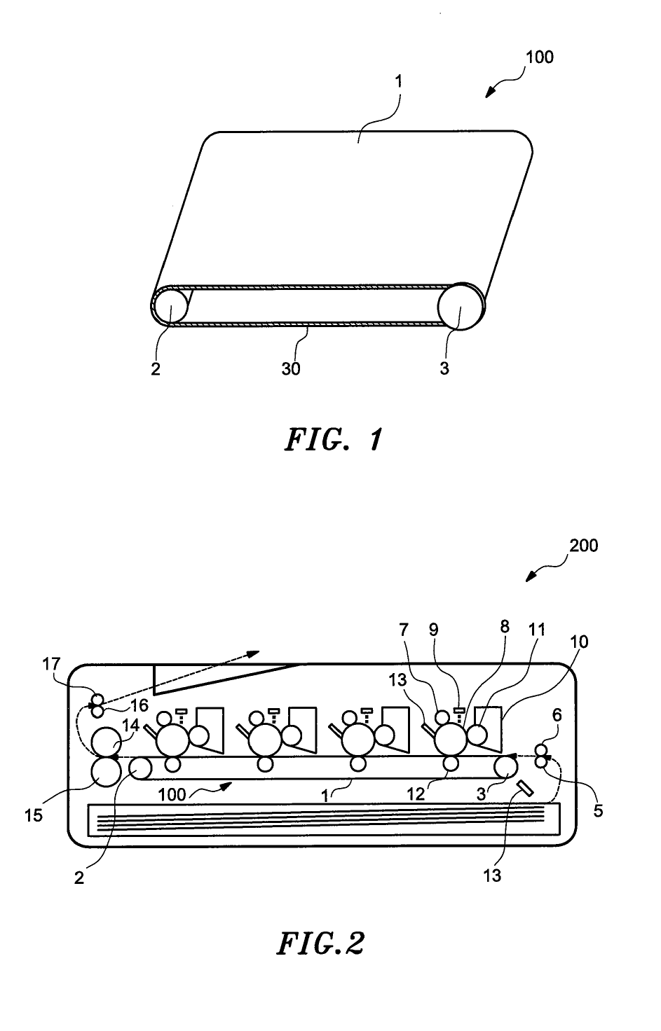

FIG. 1 is a cubic diagram for showing a structure of a belt rotating device; and FIG. 2 is a structure diagram of an image forming apparatus when it is a printer in embodiment 1.

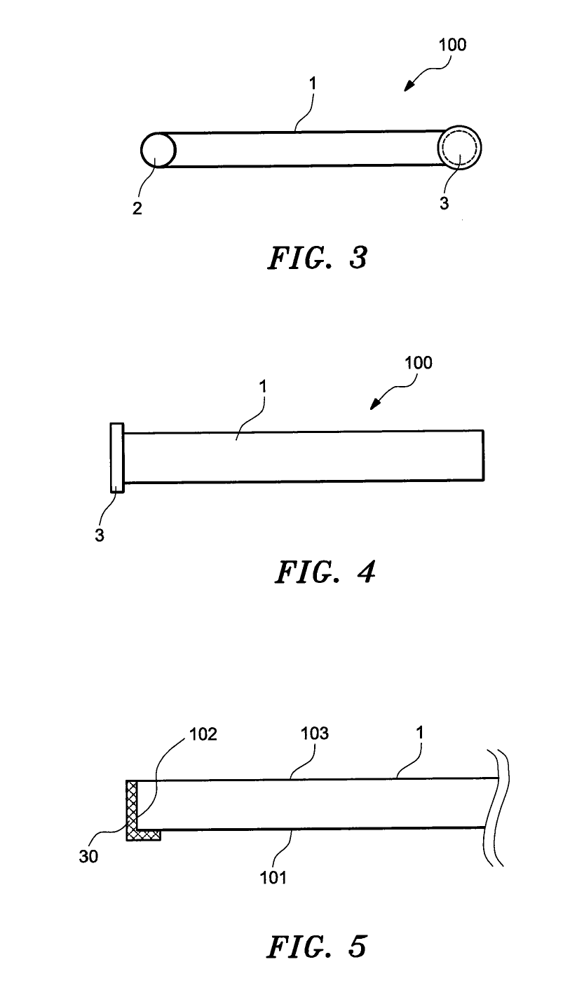

A belt rotating device 100 of embodiment 1 of the present invention, as shown by FIG. 1, includes an endless belt 1, a driving roller 2 which is furnished in inner side (inner surface) of the endless belt 1 in order to move the endless belt 1, a driven shaft (not shown) and a flange 3. Here, the belt rotating device 100, as shown by FIG. 2, is set up in an image forming apparatus 200. FIG. 3 is a front diagram for showing a structure of a belt rotating device; and FIG. 4 is a side diagram for showing a structure of a belt rotating device.

The image forming apparatus 200, as shown by FIG. 2, comprises the belt rotating device 100, a paper tray 4 holding a print medium, a conveying roller 5, a pressing roller 6, a charging roller 7, a photosensitive drum 8, a LED head 9, a toner tank 10, a developing roller 11, a transferring roller 12, a cleaning blade 13, a heating roller 14, a pressurizing roller 15, an ejecting roller 16 and a pressing roller 17.

When image data is obtained from a higher rank apparatus that is connected with the image forming apparatus 200 via network through an I/F (Inter/Face) section (not shown) of the image forming apparatus 200, the image data is stored into an image memory (not shown) by the control of a controlling section (not shown). Here, the I/F section is a communicating section that receives the image data from the higher rank apparatus and performs a notification of a process result of the received image data, is serial interface such as USB (Universal Serial Bus) and parallel interface such as IEEE1284 and is connected to the higher rank apparatus according to predetermined protocol of each interface.

Further, when a user sets a manuscript on a reading section (not shown) of the image forming apparatus 200 and instructs a print through a button furnished in an inputting section (not shown), the reading section reads the manuscript and generates image data. After the reading section generated the image data, the image data is stored into the image memory (not shown) by the control of the controlling section (not shown).

After the image data is stored in the image memory, a paper feeding roller (not shown) is rotated by the control of the controlling section (not shown), the paper feeding roller feeds the print medium held on the most top in the paper tray 4. By this, the paper feeding roller conveys the print medium.

The paper feeding roller feeds the print medium; and the conveying roller 5 is rotated by the control of the controlling section (not shown). By this, the print medium is conveyed while being sandwiched between the conveying roller 5 and the pressing roller 6 which is furnished opposite to the conveying roller 5.

After the tip of the print medium that is conveyed while being sandwiched between the conveying roller 5 and the pressing roller 6 reached a passage sensor, the photosensitive drum 8 and the driving roller 2 are rotated by the control of the controlling section (not shown).

When the photosensitive drum 8 is rotated, the charging roller 7 charges the surface of the photosensitive drum 8 by the control of the controlling section (not shown).

When the surface of the photosensitive drum 8 is charged, for example, the LED head 9 which is formed by arranging LED (Light Emitting Diode) array emits light by the control of the controlling section (not shown) and forms the electrostatic latent image on the surface of the charged photosensitive drum 8 on the basis of the image data held in the image memory.

On the one hand, after the electrostatic latent image is formed on the surface of the photosensitive drum 8, through using the toners of respective colors of yellow, magenta, cyan and black in the toner tank 10 and through the control of the controlling section, the electrostatic latent image on the photosensitive drum 8 is developed via the developing roller 11. By this, the toner image corresponding to the electrostatic latent image is formed as a visible image on the surface of the photosensitive drum 8.

On the other hand, when the driving roller 2 is rotated, the endless belt 1 is moved. By this, the print medium is conveyed by the endless belt 1, and is further conveyed while being sandwiched and held by the photosensitive drum 8 of each color and the transferring roller 12. By this, the toner image on the surface of the photosensitive drum 8 is transferred on the print medium by the transferring roller 12 where high voltage outputted from a power source section (not shown) provides by the control of the controlling section (not shown).

After the toner image on the surface of the photosensitive drum 8 is transferred on the print medium, toner remaining on the surface of the photosensitive drum 8 (remainder toner) is scraped and removed by the cleaning blade 13.

When the toner image on the surface of the photosensitive drum 8 is transferred on the print medium, the controlling section (not shown) controls a heater (not shown) that was furnished in the heating roller 14 to heat the surface of the heating roller 14 to a predetermined temperature. Here, by the control of the controlling section (not shown), the heater is supplied high voltage from the power source section (not shown) through a high voltage controlling section (not shown) and is heated.

Then, when the print medium on which the toner image is transferred is conveyed while being sandwiched between the heating roller 14 whose surface was heated to the predetermined temperature and the pressurizing roller 15 which is furnished opposite to the heating roller 14, the toner image on the print medium is heated and pressurized by the heating roller 14 and the pressurizing roller 15 and is fixed on the print medium.

The print medium that was processed to fix by the heating roller 14 and the pressurizing roller 15 is conveyed while being sandwiched by the rotating ejecting roller 16 and the pressing roller 17 that is furnished opposite to the ejecting roller 16, and is ejected from an ejection opening (not shown) of the image forming apparatus 200. By this, the print process with respect to one sheet of print medium in the image forming apparatus 200 is completed.

The driving roller 2, as shown by FIG. 1 and FIG. 3, is furnished to connect with the inner side of the endless belt 1 (inner surface 101), when the driving roller 2 is rotated by the drive of a motor (not shown), the endless belt 1 is driven to rotate. Here, the axis diameter of the driving roller 2 used in the present embodiment is Φ 25. Further, generally, as a driving roller of a belt driving apparatus that is used in the image forming apparatus 200, it is mostly used whose axis diameter is Φ 10-50 for the miniaturization of apparatus and cost.

The flange 3, as shown by FIG. 1, is structured to passively rotating by the endless belt 1, is placed on one end of a passive shaft (not shown) that is furnished to contact with the inner surface 101 of the endless belt 1, and is a guide member for preventing the endless belt 1 from meander when the endless belt 1 moves. Further, the flange 3 is structured by polyacetal (POM) that excels in sliding. Further, in the present embodiment, the case is explained to use the flange 3 which is obtained by manufacturing one side of the shaft into flange shape, however, it also may be adopt a structure to form a flange on one end of the driving roller 2 in order to prevent the endless belt 1 from meandering.

In the image forming apparatus 200 of the present embodiment, the belt rotating device 100 is furnished on a tilt with respect to a bottom plane of the image forming apparatus 200 for making the endless belt 1 in moving approach the flange 3, so it is possible to prevent the endless belt 1 from meandering when the endless belt 1 is moving through using the flange 3 that was formed on one end of the shaft.

The endless belt 1 is extended in extension force of 6±10% Kg by a spring serving as an extending means (not shown). Here, in the present embodiment, not only it is possible to use the spring as extending means and extends the endless belt 1 in the extension force of 6±10% Kg, but also it is possible to suitably select other extending means and extension force of the endless belt 1 according to belt material used in the endless belt 1 and belt driving means driving the endless belt 1. Further, the extension force is generally used by a force of 2˜8±10% Kg with respect to the endless belt 1.

FIG. 5 is a diagram for showing an endless belt that is coated with friction reduction agent.

As shown by FIG. 5, an one end surface 102 of the endless belt 1 slidably contacting to the flange 3 when the endless belt 1 is moving and an end part of the one end surface 102 of the inner surface 101 of the endless belt 1, are coated with friction reduction agent 30 for reducing the friction caused when the endless belt 1 and the flange 3 are slidably contacted to each other. The detailed explanation of the friction reduction agent 30 will be mentioned later.

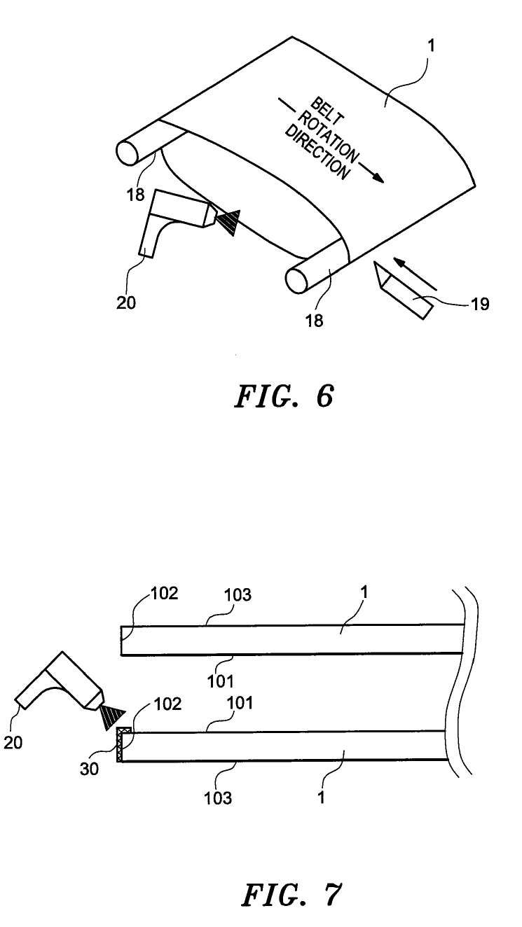

Next, the detail of the endless belt 1 is explained. FIG. 6 is an explanatory diagram concerning a generation of an endless belt. The endless belt 1 is manufactured in a measure that a film thickness is 100±10 μm, and a circumference is 624±1.5 mm through compounding carbon black of proper quantity into polyamide imide (PAI) for obtaining electric conductivity, stirring and mixing the compounded thing in a solution of N-Methyl Proridon (NMP), and rotating it.

Then, the endless belt 1 is extended and rotated by a belt tool 18 of exclusive use as shown by FIG. 6, and is finally manufactured in a width of 228±0.5 mm though a cut blade 19 cuts the endless belt 1 along the movement direction of the endless belt 1.

The structure of the PAI is a high polymer through combining amide radical and one or two imide radical/radicals via organic radical; and repeating the combination serving as one unit. In the case that the organic radical is fatty group, it is classified as fatty group PAI, in the case that the organic radical is aromatic group, it is classified as aromatic group PAI. The PAI, as a material of the endless belt 1 of the present invention, is desirable that it is the aromatic group PAI from a view for durability and mechanical characteristic. Further, the aromatic group means that organic radical, as a medium to combine the amide radical and the imide radical is one or two of benzene ring/rings.

Then, the PAI may be formed as reaching a complete imide ring closure, also may be formed as reaching a stage to generate an amide acid without imide ring closure. In the PAI, it is desirable that the part of imide ring closure is at least over 50%, better is over 70%. As a reason of using such PAI, it using the PAI in which there is too much amide acid to manufacture the endless belt 1, there is a great tendency for a measure change rate of the endless belt 1.

In the present embodiment, as the material of the endless belt 1, the PAI stated above is used. However, it is not limited by the PAI, through considering that the tension transformation caused when the endless belt 1 is driven in a constant range and the contact surfaces of the one end surface 102 of the endless belt 1 and the flange 3 contact and slide repeatedly from a viewpoint of mechanical characteristic and the durability, like the PAI, such material is desirable, which is difficult to sustain damage such as abrasion of side part, break or split of side part or the like, and whose Young's modulus is 2000 Mpa or over, further is desirably 3000 Mpa or over. As the material, resin such as Poly Imide (PI), Poly Carbonate (PC), Poly Amide (PA), Poly Ether Ether Ketone (PEEK), Poly Vinyli dene Fluoride (PVdF), Ethylene-Traacetic ethylene copolymerization (ETFE) or the like can be used, further, their respective mixtures also can be used.

In the case that the endless belt 1 is manufactured by rotation mold, a solvent is decided suitably by the material to be used, it is mostly to use organic polarity solvent, especially, N,N-dimethyl acetamide sort is used. Here, as the N,N-dimethyl acetamide sort, for example, N,N-dimethyl formamide, N,N-dimethyl acetamide, N,N-diethyl formamide, N,N-diethyl acetamide, dimethyl sulfoxide, NMP mentioned above, pyridine, tetra methylene sulfon, dimethyl tetra methylene sulfon and the like are cited. Each N,N-dimethylacetamide sort can be used individually as a solvent, plural N,N-dimethylacetamide sort can also be used jointly.

Further, on the one hand, in the case to use cylinder ring shape metal mold to form the endless belt 1 in layer between an aperture of the cylinder ring shape metal mold, the N,N-dimethylacetamide sort is also used as a solvent.

On the other hand, in the case when the endless belt 1 is manufactured by pressing-out mold, it is possible to manufacture the endless belt 1 without using the solvent.

The carbon black has complex composition that various kinds of functional radical are remained on the surface; and is added as a reinforcement agent because the carbon black suits the PAI that is the material of the endless belt 1 and the respective materials mentioned above through using the functional radical. Here, as the carbon black, such as furnest black, channel black, cathen black, acetylene black and the like are cited. Each carbon black stated above can be used individually, plural kinds of the carbon black can also be used jointly.

Further, the kind of the carbon black to be used can suitably select according to desired electroconductivity, especially, channel black and furnace black are suitably used for the endless belt 1 of the present embodiment, according to the use, it is used a matter that has been performed acidizing process, Kraft process or the like in order to prevent it from acidizing and deteriorating, or a matter that has been improved dispersiveness of the solvent. Here, in the present embodiment, as a carbon black, the channel black was used.

Furthermore, a content of the carbon black with respect to the endless belt 1 can be selected suitably to correspond to the desired electroconductivity, however, in the endless belt 1 of the present embodiment, on the basis of the necessary mechanical intensity of the endless belt 1, that was previously calculated by experiment, with respect to composition resin solid component, the content is set into 3˜40 weight %, better is 3˜30 weight %. Here, in the present embodiment, the content of the channel black with respect to the PAI is set into 15 weight %.

Next, the coating of the friction reduction agent 30 to the endless belt 1 is explained in detail.

FIG. 7 is an explanatory diagram concerning a coating of friction reduction agent to an endless belt.

The friction reduction agent 30 is accommodated in a spray 20 as shown by FIG. 6, and is used to coat the one end surface 102 of the endless belt 1 that was cut in the width measure by the cut blade 19 and an end part of the inner surface 101 at the side of the one end surface 102 through the spray 20. The spray 20, as shown by FIG. 7, is used to coat the friction reduction agent 30 on the endless belt 1 from an angle enabling the friction reduction agent 30 not to stick on the surface 103 of the endless belt 1. Further, in the present embodiment, it was not only structured by coating the friction reduction agent 30 on the one end surface 102 of the endless belt 1 and on the end part of the inner surface 101 at the side of the one end surface 102, but it can also be structured by coating the friction reduction agent 30 on the end part of the surface 103 of the endless belt 1 that is possible to slidably contact to the flange 3, at the side of the one end surface 102.

As the friction reduction agent 30, it has low surface energy by purflueolo alkyl radical; a fluorine content material is used, that the friction coefficient is small (is or less than 0.3, desirably is or less than 0.2, more desirably is or less than 0.1). Here, the fluorine content material, for example, is such as Tetra Fluoro Ethylene hexane Fluoro Propylene copolymerization body (FEP) coat, Tetra Fluoro Ethylene Par Fluoro Alkyl Vinyl Ether copolymerization body (PFA) coat, Poly Tetra Fluoro Ethylene (PTFE) coat, Fluoro Ethylene Vinyl Ether polymerization body (FEVE) coat and the like, it is possible to suitably select anyone of solvent series and dispersion series.

Further, film thickness of the friction reduction agent 30 with respect to the endless belt 1 is set to over 3 μm and under 10 μm. That is, when the friction reduction agent 30 is thinner than 3 μm, the friction reduction agent 30 drops off from the endless belt 1 by repeated contact and slide with the flange 3. Further, when the friction reduction agent 30 is thicker than 10 μm, because the friction in contact and slide with the flange 3 becomes great, the friction reduction agent 30 drops off from the endless belt 1. For this, when the friction reduction agent 30 is thinner than 3 μm and thicker than 10 μm, because the friction reduction agent 30 drops off from the endless belt 1, the friction cannot be reduced, as a result, crack of the endless belt 1 occurs.

The cleaning blade 13 is used for scraping and removing the toner sticking on the surface 103 of the endless belt 1. The cleaning blade 13 is structured by urethane rubber whose rubber hardness (measurement method: JIS K6301, measurement machine: JISA) is JIS A of 83°; and whose thickness is 1.5 mm, and is set to make static line pressure toward the endless belt 1 become 4.3 g/mm. Here, as a reason that the cleaning blade 13 that was structured by the urethane rubber is used, it is because a blade manner that is formed from elastic material such as the urethane rubber and the like excels in function for removing such as remaining toner, alien substance and the like; it is because the structure is simple, compact and low cost;

further it is because the urethane rubber, as rubber material, is high hardness and rich in elastic, is excellent in that such as abrasion resistivity, mechanical intensity, oil resistivity and ozone resistivity and the like.

The toner used in the image forming apparatus 200 of the present invention, is formed by using styrene acrylic copolymerization body as main structure ingredient, and making paraffin wax be contained by 9% according to emulsification polymerization method, so that the toner has an average particle diameter of 7 μm and has a perfect ball extent of 0.95. Here, as a reason to use the toner that was structured by the ingredient, it is because the main structure ingredient of the toner has an effect capable of realizing a transfer efficiency improvement, a disuse of mold release agent of fixation and a development which excels in dot reproducibility and in development extent, by this, it is possible to obtain sharpness of the image and high image quality.

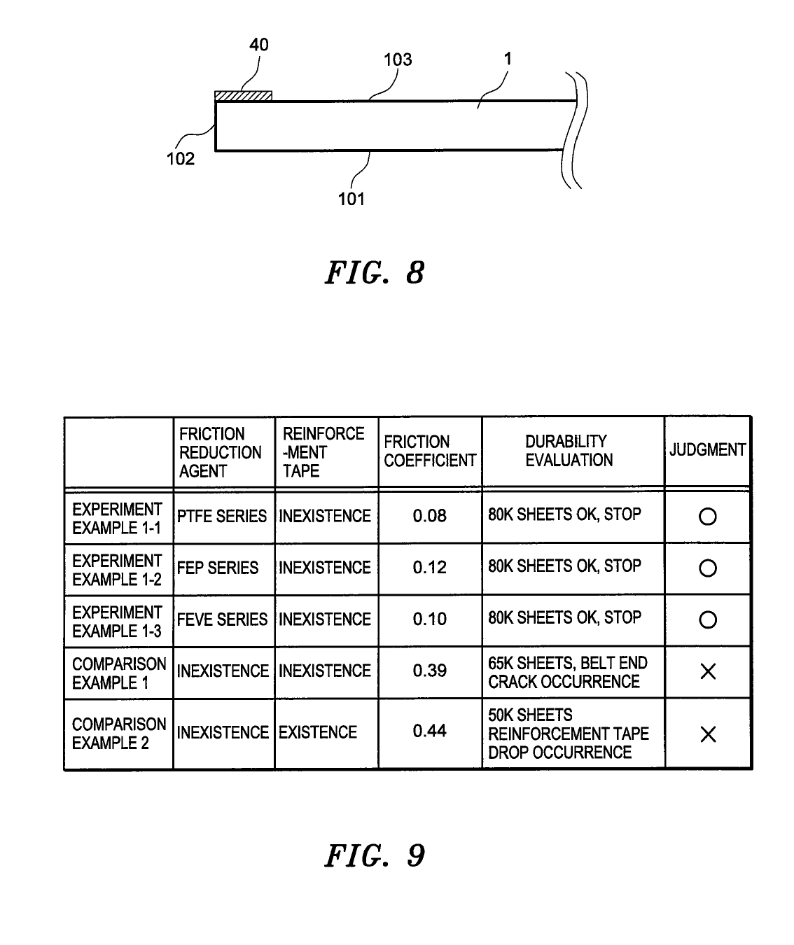

FIG. 8 is a diagram for showing an endless belt that is stuck reinforcement tape; and FIG. 9 is a diagram for showing a result of a durability evaluation with respect to an image forming apparatus of embodiment 1.

The experiment result about a durability evaluation of the endless belt 1 of the embodiment of the present invention is shown in FIG. 9. Here, regarding the durability evaluation, as the image forming apparatus, a printer C5800n which is made by Oki Data Corporation is used. And, as a print medium, ordinary paper of A4 size is used. Further, as a print pattern, it is based on a print to print lines of Y, M, C, K colors in a density of 3% per print medium. Furthermore, the print is performed according to a print condition of 3P/J (that is, such operation that stops 7 seconds after printed 3 sheets).

The durability evaluation of the endless belt 1, is what that investigated an existence and an inexistence of the breakage of the endless belt 1 when the print process was performed with respect to 80 k sheets of the print medium in the image forming apparatus 200.

In the item of “judgment” of FIG. 9, when the print process with respect to 80k sheets of the print medium is performed by using the image forming apparatus 200, in the case that the endless belt 1 was not damaged, mark “◯” is stated; in the case that the endless belt 1 was damaged before the print process is performed, mark “×” is stated.

In the item of “friction reduction agent” of FIG. 9, when the print process with respect to 80 k sheets of the print medium by using the image forming apparatus 200 is performed, in the case that the friction reduction agent 30 was coated on the endless belt 1, the main structure ingredient of the friction reduction agent 30 is stated; in the case that the friction reduction agent 30 was not coated, “inexistence” is stated.

In the present embodiment, as the durability evaluation of the endless belt 1, instead of the friction reduction agent 30, as shown by FIG. 8, an experiment is performed in the case that reinforcement tape 40 is stuck on an end part of the one end surface 102 side of the surface 103 of the endless belt 1 in order to reinforce the end part. Here, the reinforcement tape 40 is formed by using a material of Poly Ethylene Terephthalic rate (PET) whose thickness is 50 μm. Further, the reinforcement tape 40 is stuck on the end part stated above of the surface 103 of the endless belt 1 by acrylic series adhesion material serving as a medium.

In the item of “reinforcement tape” of FIG. 9, when the print process with respect to 80 k sheets of the print medium by using the image forming apparatus 200 is performed, in the case that the reinforcement tape 40 was stuck on the endless belt 1, “existence” is stated; in the case that the reinforcement tape 40 was not stuck on the endless belt 1, “inexistence” is stated.

FIG. 13 is an explanatory diagram for explaining a calculation a friction coefficient.

In the item of “friction coefficient” of FIG. 9, to correspond to experiment example 1-1˜1-3, comparison example 1 and 2 (stated later), the friction coefficient in the contact surfaces of the one end surface 102 of each endless belt 1 and the flange 3 is stated. As shown by FIG. 13, each friction coefficient in FIG. 9 is calculated by the experiment to pull the endless belt 1 with a force of F while the endless belt 1 which is added a measure weight of 100 g slidably contacts to the flange 3. The friction coefficient that is used in the experiment example is measured by the method that is called Euler belt manner (The Japan Society of Mechanical Engineers, JSME Mechanical Engineers' Handbook Fundamentals, A3 Dynamics. Dynamics of Machinery, p 35 (1986)) and is calculated by the following friction coefficient calculation formula.

friction coefficient μ=ln {(F/W)/(π/2)} (1)
ln=natural logarithm
F=friction force
W=weight of a measure weight

In the item of “comparison example 1” of FIG. 9, the experiment result is shown about the durability evaluation in the contact surface between the flange 3 and the endless belt 1 which is not coated by the friction reduction agent 30 of the present invention and is not stuck by the reinforcement tape 40 of the present invention. Here, in the endless belt 1 that is not performed the coating of the friction reduction agent 30 and the stick of the reinforcement tape 40, the friction coefficient in the contact surface is 0.39. And, in the image forming apparatus 200 having the belt rotating device 100 for rotating the endless belt 1, when 65 k sheets of the print medium are performed as a print process, crack occurred on the one end surface 102 of the endless belt 1.

In the item of “comparison example 2” of FIG. 9, the experiment result is shown about the durability evaluation in the contact surface between the flange 3 and the endless belt 1 in which stuck by the reinforcement tape 40 an end part of the surface 103 at the side of the one end surface 102. Here, in the endless belt 1 that is stuck by the reinforcement tape 40, the friction coefficient in the contact surface is 0.44. And, in the image forming apparatus 200 having the belt rotating device 100 for rotating the endless belt 1, when 50 k sheets of the print medium are printed as a print process, the reinforcement tape 40 that was stuck on the endless belt 1 drops off.

According to the experiment result of the “comparison example 2”, in the endless belt 1 that is stuck by the reinforcement tape 40, through comparing with the endless belt 1 of the “comparison example 1” without the coating of the friction reduction agent 30 and the stick of the reinforcement tape 40, a value of the “friction coefficient” is higher. Further, as a reason that the reinforcement tape 40 drops off from the endless belt 1, it is because the reinforcement tape 40 was stuck on the endless belt 1 by using the adhesion material, but the adhesion force of the adhesion material falls due to a use environment such as temperature and humidity, especially due to high temperature, so it is easy to occur a deviation and a drop for the reinforcement tape 40 accompanying with the use of the endless belt 1 in the image forming apparatus 200.

Further, in the case that the sticking is performed without considering a measure change rate between the endless belt 1 and the reinforcement tape 40, which is caused by environmental change such as temperature and humidity, the reinforcement tape 40 will be stuck on the endless belt 1 in a wavy state, therefore, it is difficult to stick such reinforcement tape 40.

Furthermore, it is difficult for the reinforcement tape 40 to be stuck smoothly on the one end surface 102 of the endless belt 1, if trying to realize it, because it is exceedingly difficult in technique as well, a great deal of equipment and time become necessary.

Therefore, because to stick the reinforcement tape 40 on the one end surface 102 of the endless belt 1 brings about a rise of the friction coefficient in the contact surface between the endless belt 1 and the flange 3, a fall of throw put and a rise of cost, so it is unsuitable.

In the “experiment example 1-1” of FIG. 9, the experiment result of the durability evaluation of the endless belt 1 that was coated with the friction reduction agent 30 of the Poly Tetra Fluoro Ethylene (PTFE) series on the one end surface 102 of the endless belt 1 and on an end part of the inner surface 101 at the side of the one end surface 102 is shown. Here, in the endless belt 1 that was coated with the friction reduction agent 30 of the PTFE series, the friction coefficient in the contact surface between the endless belt 1 and the flange 3 is 0.08. And, in the image forming apparatus 200 having the belt rotating device 100 for rotating the endless belt 1, even if 80 k sheets of the print medium are printed as a print process, a breakage was not caused on the one end surface 102 of the endless belt 1.

In the “experiment example 1-2” of FIG. 9, the experiment result of the durability evaluation of the endless belt 1 that was coated with the friction reduction agent 30 of the Tetra Fluoro Ethylene hexane Fluoro Propylene copolymerization body (FEP) series on the one end surface 102 of the endless belt 1 and on the end part of the inner surface 101 at the side of the one end surface 102 is shown. Here, the friction coefficient in the contact surface between the endless belt 1 that was coated with the friction reduction agent 30 of the FEP series and the flange 3 is 0.12. And, in the image forming apparatus 200 having the belt rotating device 100 for rotating the endless belt 1, even if 80 k sheets of the print medium are printed as a print process, a breakage was not caused on the one end surface 102 of the endless belt 1.

In the “experiment example 1-3” of FIG. 9, the experiment result of the durability evaluation of the endless belt 1 that was coated with the friction reduction agent 30 of the Fluoro Ethylene Vinyl Ether polymerization body (FEVE) series on the one end surface 102 of the endless belt 1 and the end part of the inner surface 101 at the side of the one end surface 102 is shown. Here, the friction coefficient in the contact surface between the endless belt 1 that was coated with the friction reduction agent 30 of the FEVE series and the flange 3 is 0.10. And, in the image forming apparatus 200 having the belt rotating device 100 for rotating the endless belt 1, even if 80 k sheets of the print medium are printed as a print process, a breakage was not caused on the one end surface 102 of the endless belt 1.

According to the result of the durability evaluation of the experiment examples 1-1˜1-3, it was proved that the friction coefficient in the endless belt 1 that was coated with the friction reduction agent 30 on the one end surface 102 of the endless belt 1 and on the end part of the inner surface 101 at the side of the one end surface 102 is reduced comparing with the friction coefficient on the basis of the experiment result of the comparison example 1. As a reason that the friction coefficient is reduced, it is because tiny unevennesses existing on the endless belt 1 are slightly covered with the friction reduction agent 30 though the one end surface 102 of the endless belt 1 and the end part of the inner surface 101 at the side of the one end surface 102 are coated with the friction reduction agent 30, and the unevennesses are reduced. By this, through coating the friction reduction agent 30 on the endless belt 1, a sliding and shearing force (friction force) in the contact surface between the endless belt 1 and the flange 3 is reduced; unequal stress concentration to the one end surface 102 of the endless belt 1 becomes small, as a result, the durability of the endless belt 1 can be improved.

Further, in theory, it is better when the friction coefficient in the contact surface is 0, but it is difficult to make the friction reduction agent to make the friction coefficient of the contact surface 0 in practice. In the present invention, it was proved by the experiment that if the friction coefficient of the contact surface between the endless belt 1 that was coated with the friction reduction agent 30 and the flange 3 is 0.08 or over and is 0.12 or below, enough effect with respect to the improvement of the durability of the endless belt 1 can be obtained.

### Effect of Embodiment 1

According to the image forming apparatus 200 of the embodiment 1 of the present invention, through having the endless belt 1 that is coated with the friction reduction agent 30 on the one end surface 102 of the endless belt 1 and the end part of the one end surface 102 side of the inner surface 101, it is possible to improve the durability with respect to the flexion fatigue of the endless belt 1 and to reduce the occurrence of the breakage of the endless belt 1.

### Embodiment 2

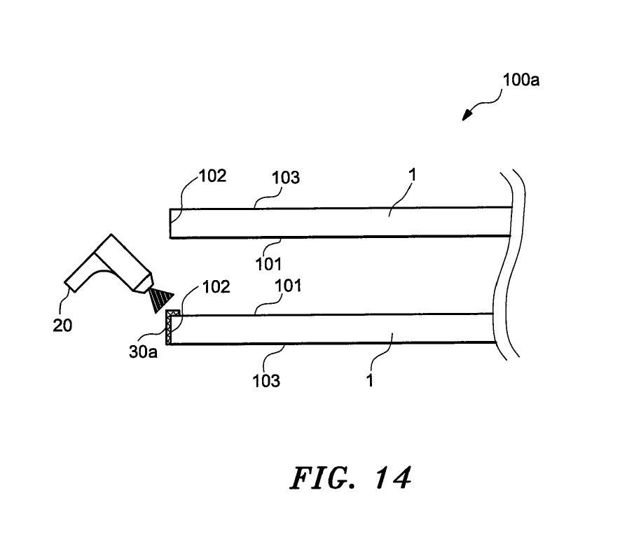

FIG. 14 is an explanatory diagram for showing a main part of a belt rotating device in embodiment 2.

In a belt rotating device 100a of embodiment 2 of the present invention, instead of the friction reduction agent 30 that was used to coat the endless belt 1 in the belt rotating device 100 of the embodiment 1, a friction reduction agent 30a is used to coat the endless belt 1, the friction reduction agent 30a has a paint film hardness that is set on the basis of the durability evaluation that was performed with respect to the paint film of the friction reduction agent covering the endless belt 1.

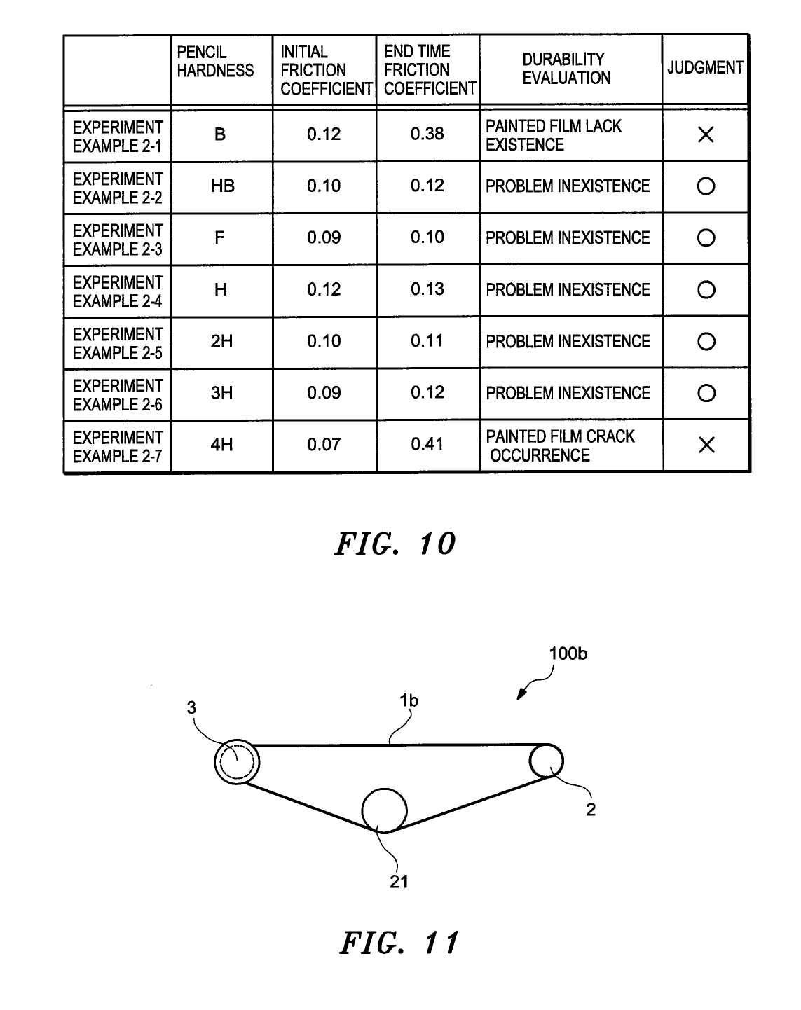

FIG. 10 is a diagram for showing a result of a durability evaluation with respect to an image forming apparatus of embodiment 2.

As a paint film of the friction reduction agent 30a that covers the one end surface 102 and the end part of the inner surface 101 at the side of the one end surface 102 of the endless belt 1 of the belt rotating device 100a which is used in the image forming apparatus, in order to investigate what kind of the paint film is suitable, the endless belt 1 that was coated the paint film of the friction reduction agent 30a of each pencil hardness stated later in experiment example 2-1˜2-7 as shown by FIG. 10, is prepared. Here, the friction reduction agent 30a of each pencil hardness in the experiment example 2-1˜2-7, is formed from material of FEVE series as main ingredient, and generates the paint film of each pencil hardness on the endless belt 1 through adjusting the alkyl radical combining the ether of the vinyl ether radical.

In the “pencil hardness” of FIG. 10, the paint film hardness of the friction reduction agent 30a that was coated on the one end surface 102 of the endless belt 1 and on the end part of the inner surface 101 at the side of the one end surface 102 is stated. Here, the paint film hardness of the friction reduction agent 30a is measured on the basis of the test of JIS K5600-5-4 scratch hardness (pencil method).

Further, regarding each value (B, HB, F, H, 2H, 3H, 4H) of the “pencil hardness”, it represents a value biggest hardness in the case that uni-pencil of Mitsubishi pencil Co., Ltd. is pressed and slid at an angle of 45±1° with respect to the paint film of the friction reduction agent 30a and is pressed and slid with a load of 750±10 g in the perpendicular direction with respect to the paint film.

The experiment result about the durability evaluation of the endless belt 1 of each pencil hardness in the experiment example 2-1˜2-7 of the embodiment 2 of the present invention is shown in FIG. 10. Here, regarding the durability evaluation, the same as the durability evaluation of the endless belt 1 of the embodiment 1, the printer C5800n which is made by Oki Data Corporation is used as the image forming apparatus. And, as a print medium, ordinary paper of A4 size is used. Further, as a print pattern, it is based on a print to print lines of Y, M, C, K colors in a density of 3% per print medium.

Furthermore, the print is performed according to a print condition of 3P/J.

The durability evaluation of the endless belt 1, is what that investigated an existence and an inexistence of the breakage of the endless belt 1 when the print process was performed with respect to 60 k sheets of the print medium in the image forming apparatus.

In the “judgment” of FIG. 10, when the print process with respect to 60 k sheets of the print medium is performed by using the image forming apparatus, in the case that a drop or the like does not occur for the friction reduction agent 30a that was coated on the endless belt 1, mark “◯” is stated; in the case that such as drop occurred before the print process is performed, mark “×” is stated.

In the “initial friction coefficient” of FIG. 10, the friction coefficient of the one end surface 102 of the endless belt 1 which is unused in the print process and which is coated with the friction reduction agent 30a of each pencil hardness in the experiment example 2-1˜2-7, is stated. Here, each initial friction coefficient of FIG. 10 is calculated by the same calculating method of each initial friction coefficient of FIG. 9.

In the “end time friction coefficient” of FIG. 10, the friction coefficient of the one end surface 102 of the endless belt 1 which has been used in the completed print process with respect to 60k sheets of the print medium and which is coated with the friction reduction agent 30a of each pencil hardness in the experiment example 2-1˜2-7 is stated. Here, each initial friction coefficient of FIG. 10 is calculated by the same calculating method of each initial friction coefficient of FIG. 9.

Corresponding to the “experiment example 2-1” of FIG. 10, an experiment result is shown about the durability evaluation of the endless belt 1 that was coated with the friction reduction agent 30a of pencil hardness B in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness B is 0.12, and the end time friction coefficient is 0.38. In the case, in the image forming apparatus having the belt rotating device 100a for rotating the endless belt 1, when a print process is completed with respect to 60 k sheets of print medium, the paint film of the friction reduction agent 30a that was coated on the endless belt 1 drops off.

Corresponding to the “experiment example 2-2” of FIG. 10, an experiment result is shown about the durability evaluation of the endless belt 1 that was coated with the friction reduction agent 30a of pencil hardness HB in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness HB is 0.10, and the end time friction coefficient is 0.12. In the case, in the image forming apparatus having the belt rotating device 100a for rotating the endless belt 1, even if a print process is completed with respect to 60 k sheets of print medium, the paint film of the friction reduction agent 30a that was coated on the endless belt 1 is not damaged.

Corresponding to the “experiment example 2-3” of FIG. 10, an experiment result is shown about the durability evaluation of the endless belt 1 that was coated with the friction reduction agent 30a of pencil hardness F in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness F is 0.09, and the end time friction coefficient is 0.10. In the case, in the image forming apparatus having the belt rotating device 100a for rotating the endless belt 1, even if a print process is completed with respect to 60 k sheets of print medium, the paint film of the friction reduction agent 30a that was coated on the endless belt 1 is not damaged.

Corresponding to the “experiment example 2-4” of FIG. 10, an experiment result is shown about the durability evaluation of the endless belt 1 that was coated with the friction reduction agent 30a of pencil hardness H in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness H is 0.12, and the end time friction coefficient is 0.13. In the case, in the image forming apparatus having the belt rotating device 100a for rotating the endless belt 1, even if a print process is completed with respect to 60 k sheets of print medium, the paint film of the friction reduction agent 30a that was coated on the endless belt 1 is not damaged.

Corresponding to the “experiment example 2-5” of FIG. 10, an experiment result is shown about the durability evaluation of the endless belt 1 that was coated with the friction reduction agent 30a of pencil hardness 2H in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness 2H is 0.10, and the end time friction coefficient is 0.11. In the case, in the image forming apparatus having the belt rotating device 100a for rotating the endless belt 1, even if a print process is completed with respect to 60 k sheets of print medium, the paint film of the friction reduction agent 30a that was coated on the endless belt 1 is not damaged.

Corresponding to the “experiment example 2-6” of FIG. 10, an experiment result is shown about the durability evaluation of the endless belt 1 that was coated with the friction reduction agent 30a of pencil hardness 3H in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness 3H is 0.09, and the end time friction coefficient is 0.12. In the case, in the image forming apparatus having the belt rotating device 100a for rotating the endless belt 1, even if a print process 60 k sheets with respect to 60 k sheets of print medium, the paint film of the friction reduction agent 30a that was coated on the endless belt 1 is not damaged.

Corresponding to the “experiment example 2-7” of FIG. 10, an experiment result is shown about the durability evaluation of the endless belt 1 that was coated with the friction reduction agent 30a of pencil hardness 4H in Poly Tetra Fluoro Ethylene (PTFE) series on its one end surface 102 and on end part of its inner surface 101 placed at the side of the one end surface 102. Here, the initial friction coefficient of the one end surface 102 of the endless belt 1 that was covered with the paint film of the friction reduction agent 30a of the pencil hardness 4H is 0.07, and the end time friction coefficient is 0.41. In the case, in the image forming apparatus having the belt rotating device 100a for rotating the endless belt 1, when a print process is completed with respect to 60 k sheets of print medium, crack occurs on the paint film of the friction reduction agent 30a that was coated on the endless belt 1.

According to the result of the durability evaluation of the experiment example 2-1˜2-7, on the one end surface 102 of the endless belt 1 and the end part of the inner surface 101 placed at the side of the one end surface 102 that were covered with the paint film of the friction reduction agent 30a of the pencil hardness HB˜3H, the breakage did not occur on the paint film. According to the result stated above, it is possible to improve the durability with respect to the flexion fatigue of the endless belt 1 through coating with the paint film of the friction reduction agent 30a of the pencil hardness HB˜3H on the one end surface 102 of the endless belt 1 and on the end part of the inner surface 101 placed at the side of the one end surface 102.

Further, according to the result of the experiment example 2-1, in the case that the paint film of the friction reduction agent 30a whose hardness is low as the pencil hardness B is used to coat the one end surface 102 of the endless belt 1 and the end part of the inner surface 101 at the side of the one end surface 102, though the performance of flexion and follow is excellent with respect to the repeated rotation of the endless belt 1, because it degrades in abrasion resistivity, it was proved that the paint film is lacking in performance.

Furthermore, according to the result of the experiment exaeple 2-7, in the case that the paint film of the friction reduction agent 30a whose hardness is high as the pencil hardness 4H is used to coat the one end surface 102 of the endless belt 1 and the end part of inner surface 101 at the side of the one end surface 102, though the abrasion resistivity with respect to the repeated rotation of the endless belt 1 is excellent, because it degrades in the performance of flexion and follow, it was proved that crack occurs in the paint film and the paint film drops in a short time.

### Effect of Embodiment 2

According to the image forming apparatus of the embodiment 2, through correctly controlling the hardness of the paint film of the friction reduction agent 30a on the one end surface 102 of the endless belt 1 and on the end part of the inner surface 101 at the side of the one end surface 102, it is possible to improve the durability with respect to the flexion fatigue of the endless belt 1 comparing with the image forming apparatus 200 of the embodiment 1 and to reduce the occurrence of the breakage of the endless belt 1.

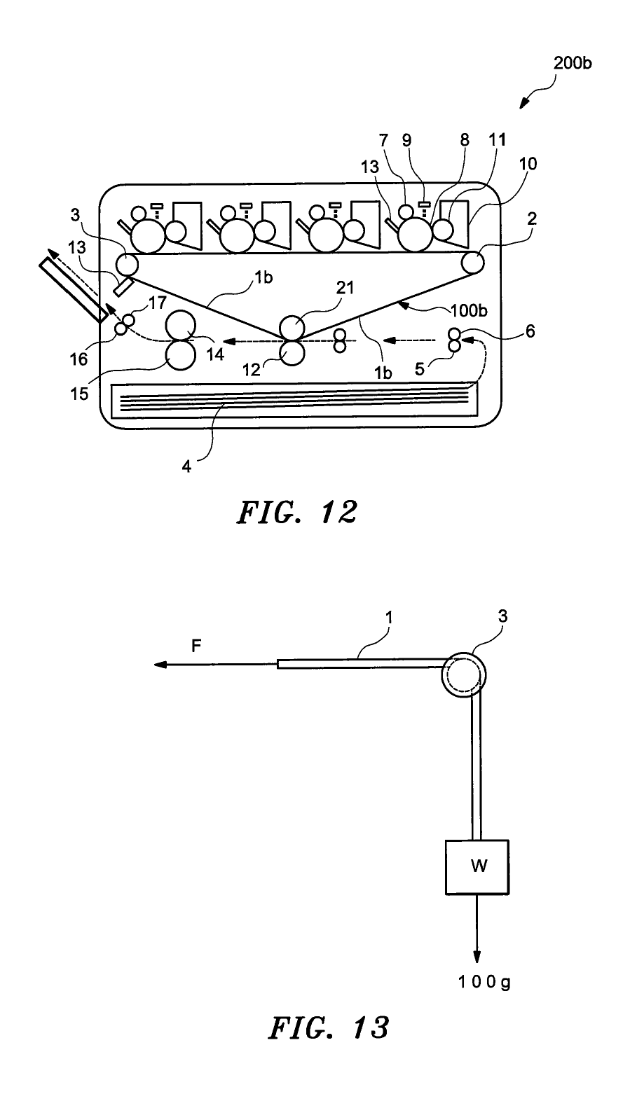

FIG. 11 is a front diagram for showing a structure of a belt rotating device; and FIG. 12 is a structure diagram of an image forming apparatus when it is a printer in embodiment 2.

Moreover, in the embodiment of the present invention, regarding the endless belt 1, the flange 3 and the friction reduction agent 30 that are used in the above-mentioned image forming apparatus 200 (FIG. 2) of tandem system and the belt rotating device 100 (FIG. 1) which is furnished in the image forming apparatus 200, they are explained, but it is possible for the endless belt 1, the flange 3 and the friction reduction agent 30 to apply to the image forming apparatus 200b (FIG. 12) of intermediate transfer belt system and to the belt rotating device 100b (FIG. 11) which is furnished in the image forming apparatus 200b.

The belt rotating device 100b (FIG. 11) is structured by the endless belt 1, the driving roller 2 which is furnished on the inner side (the inner surface 101) of the endless belt 1, the flange 3 that is added on an one end of a rotation supporting member (not shown) and the rotation supporting member 21. When the driving roller 2 rotates by control of a controlling section (not shown) of the belt rotating device 100b, the endless belt 1 moves. Here, regarding the belt rotating device 100b, the case that the flange 3 is added on the one end of the rotation supporting member (not shown) is explained, but it can also be structured by adding the flange 3 to at least one part of both ends of the rotation supporting member, the driving roller 2, or the rotation supporting member 21.

The image forming apparatus 200b, as shown by FIG. 12, comprises the belt rotating device 100b, a paper tray 4 holding a print medium, a conveying roller 5, a pressing roller 6, a charging roller 7, a photosensitive drum 8, a LED head 9, a toner tank 10, a developing roller 11, a transferring roller 12, a cleaning blade 13, a heating roller 14, a pressurizing roller 15, an ejecting roller 16 and a pressing roller 17. Here, the rotation supporting member 21 of the belt rotating device 100b is furnished opposite to the transferring roller 12 through the endless belt 1. Further, the explanation about the print process operation of the image forming apparatus 200b is omitted because it is known commonly.

### The Utilization Possibility in Industry

In the embodiment stated above, it is not only to explain the case of the belt rotating device rotating the endless belt 1 that was coated with the friction reduction agent on the one end surface 102 of the endless belt 1 and on the end part of the inner surface 101 at the side of the one end surface 102 where the belt rotating device of the present invention is the belt of endless shape, for example, but it also can be applied to the belt rotating device rotating the belt with a end existence shape, the belt with a end existence shape is coated with the friction reduction agent on its one end surface and on end part of its inner surface at the side of the one end surface.

Further, in the embodiment stated above, the example is explained to apply the belt rotating device of the present invention for rotating the print medium conveyance use belt, as a belt rotating device. However, the present invention is not limited by the example, the present invention also can be applied to such belt rotating device for rotating belt shape photosensitive body and such belt rotating device for rotating belt-shaped intermediate transfer body.

Furthermore, in the embodiment stated above, the example is explained to apply the image forming apparatus having the belt rotating device of the present invention as a printer, but the present invention is not limited by the example, the present invention also can be applied to such device as duplex machine.

The present invention is not limited to the foregoing embodiments but many modifications and variations are possible within the spirit and scope of the appended claims of the invention.

What is claimed is:

1. A belt rotating device, comprising:
a belt that is wound on a roller driven by a predetermined driving means; and
a meander prevention member that is slidably contacted with an end surface of the belt for preventing a meander of the belt,
wherein a friction reduction agent for reducing slide friction with respect to the meander prevention member is formed to coat at least the end surface of the belt.

2. The belt rotating device according to claim 1,
wherein a friction coefficient of a contact surface of the belt that is coated with the friction reduction agent is smaller than that of a contact surface of the belt that is not coated with the friction reduction agent.

3. The belt rotating device according to claim 1,
wherein the friction coefficient of the contact surface of the belt that is coated with the friction reduction agent is 0.08 or over and is 0.12 or below.

4. The belt rotating device according to claim 1,
wherein a pencil hardness of a paint film of the friction reduction agent that is coated on the belt is HB or over and is 3H or below.

5. An image forming apparatus, comprising:
a belt rotating device for rotating a belt,
wherein the belt rotating device, includes:
a belt that is wound on a roller driven by a predetermined driving means; and
a meander prevention member that is slidably contacted with an end surface of the belt for preventing a meander of the belt,
wherein a friction reduction agent for reducing slide friction with respect to the meander prevention member is formed to coat at least the end surface of the belt.

6. The image forming apparatus according to claim 5,
wherein the belt is one of a print medium conveyance use belt, a belt-shaped image carrying body and a belt-shaped intermediate transfer body.
